(19) United States
(12) Patent Application Publication
(10) Pub. No.: US 2018/0331485 A1
(43) Pub. Date: Nov. 15, 2018

(54) METHOD OF MANUFACTURING TERMINAL-EQUIPPED CONDUCTIVE MEMBER, CONDUCTIVE MEMBER, AND TERMINAL-EQUIPPED WIRE

(71) Applicant: SUMITOMO WIRING SYSTEMS, LTD., Mie (JP)

(72) Inventors: Osamu SATOU, Mie (JP); Jiguo ZHENG, Mie (JP); Masamichi YAMAGIWA, Mie (JP)

(73) Assignee: SUMITOMO WIRING SYSTEMS, LTD., Mie (JP)

(21) Appl. No.: 15/773,825

(22) PCT Filed: Nov. 2, 2016
(86) PCT No.: PCT/JP2016/082628

§ 371 Date: May 4, 2018

(30) Foreign Application Priority Data
Nov. 12, 2015 (JP) 2015-221833

(51) Int. Cl. H01R 43/28; H01R 43/02; H01R 4/18; H01R 43/048; H01B 5/12

(52) U.S. Cl. CPC H01R 43/28; H01R 43/0263; H01R 11/12; H01R 43/048; H01B 5/12; H01R 4/187

(57) ABSTRACT

The present invention seeks to provide a technology that crimps a terminal and a conductive member configured by a plurality of metal strands together in a more stable state. A method of manufacturing a terminal-equipped conductive member is performed using a die, which includes a first die having a projection and a second die, the second die having a depression into which the projection can be inserted, and having a pair of side wall surfaces of the depression which include a first molding surface inclined along an inner surface of a pair of crimping tabs of a pre-crimping terminal, the method including a welding step of arranging in the die a welded portion formation region, which is a region on an extension direction portion of a conductive member, and welding the plurality of metal strands together; and a crimping step of crimping the welded portion and the terminal together.

### FIELD OF THE INVENTION

The present invention relates to a conductive member that includes a plurality of metal strands, and to a method of manufacturing in which a terminal-equipped conductive member provided with a conductive member and a terminal is manufactured.

### BACKGROUND OF THE INVENTION

In a wire harness mounted in a vehicle such as an automobile, a terminal-equipped wire has a terminal crimped to an end portion of a wire.

In an example given in Patent Literature 1, a terminal-equipped wire is produced using a braided wire as the wire, for example. In Patent Literature 1, an end portion of the braided wire is welded and a swaging portion is created, then a terminal is crimped to the swaging portion.

### RELATED ART

### Patent Literature

Patent Literature 1: Japanese Patent Laid-open Publication No. 2015-060632

### SUMMARY OF THE INVENTION

### Problems to Be Solved by the Invention

In the example given in Patent Literature 1, a cross-sectional shape of the swaging portion, as sectioned by a plane orthogonal to an extension direction of the wire, is rectangular. In such a case, the work of crimping to the terminal is carried out in an unstable state where a corner of the swaging portion touches an inner surface of a crimping portion of the pre-crimping terminal. Therefore, the state of crimping the wire and the terminal together is likely to become unstable.

The present invention seeks to provide a technology that crimps a terminal and a conductive member configured by a plurality of metal strands together in a more stable state.

### Means for Solving the Problems

A method of manufacturing a terminal-equipped conductive member according to a first aspect is performed using a die, which includes a first die having a projection and a second die, the second die having a depression into which the projection can be inserted, and having a pair of side wall surfaces of the depression which include a first molding surface inclined along an inner surface of a pair of crimping tabs of a pre-crimping terminal, the method including a welding step of arranging in the die a welded portion formation region, which is a region on an extension direction portion of a conductive member configured by a plurality of metal strands, and welding the plurality of metal strands together; and a crimping step of arranging on an interior of the pair of crimping tabs of the pre-crimping terminal a welded portion, which is formed by performing the welding step on the welded portion formation region and which is formed with an inclined surface corresponding to the first molding surface of the second die, and crimping the welded portion and the terminal together.

A method of manufacturing a terminal-equipped conductive member according to a second aspect is one mode of the method of manufacturing a terminal-equipped conductive member according to the first aspect. In the method of manufacturing a terminal-equipped conductive member according to the second aspect, the conductive member is configured by a plurality of coated metal wires provided with the plurality of metal strands and with an electrically conductive sheath covering a circumference of each of the plurality of metal strands, and the welding step is a step where heating is performed at a temperature higher than the melting point of the sheaths and lower than the melting point of the metal strands, and is a step where the plurality of coated metal wires are welded to each other.

A method of manufacturing a terminal-equipped conductive member according to a third aspect is one mode of the method of manufacturing a terminal-equipped conductive member according to the first or second aspect. In the method of manufacturing a terminal-equipped conductive member according to the third aspect, the pair of side wall surfaces include the first molding surface provided toward a bottom portion of the depression; and a second molding surface, which is provided on an opposite side of the first molding surface from the bottom portion and extends along a direction in which the first die and the second die separate from each other.

A method of manufacturing a terminal-equipped conductive member according to a fourth aspect is one mode of the method of manufacturing a terminal-equipped conductive member according to any one of the first to third aspects. In the method of manufacturing a terminal-equipped conductive member according to the fourth aspect, the first die includes a contact portion that, when the projection is inserted into the depression by a predetermined amount, makes contact with a portion of the depression of the second die that faces the first die.

A conductive member according to a fifth aspect is configured by a plurality of metal strands, and includes a welded portion where at least a portion in an extension direction of the plurality of metal strands is welded, and an outer surface on each of two lateral sides of the welded portion includes an inclined surface that inclines gradually outward, the incline progressing from one side of a thickness direction to the other.

A conductive member according to a sixth aspect is one mode of the conductive member according to the fifth aspect. In the conductive member according to the sixth aspect, the conductive member is configured by a plurality of coated metal wires provided with the plurality of metal strands and with an electrically conductive sheath covering a circumference of each of the plurality of metal strands, and the welded portion includes a portion where the plurality of metal strands are bonded together by a portion where the sheaths have melted and solidified.

### Effect of the Invention

In the first aspect, the method of manufacturing a terminal-equipped conductive member is performed using the die, which includes the first die having the projection and the second die, the second die having the depression into which the projection can be inserted, and having the pair of side wall surfaces of the depression which include the first molding surface inclined along the inner surface of the pair of crimping tabs of the pre-crimping terminal. In addition, the welded portion is formed by performing the welding step. In such a case, the inclined surface is formed on the welded portion, the inclined surface corresponding to the first molding surface of the depression of the second die. The inclined surface formed on the welded portion is a surface that inclines along the inner surface of the pair of crimping tabs of the pre-crimping terminal. Therefore, in the crimping step, by bringing the inclined surface of the welded portion into contact with the inner surface of the pair of crimping tabs of the pre-crimping terminal, a state can be achieved where the welded portion is stably arranged inside the pair of crimping tabs of the pre-crimping terminal. Then, by performing the task of crimping the terminal and the welded portion together in such a state, the conductive member and the terminal can be crimped together more stably.

In addition, in the second aspect, the plurality of metal strands are bonded together by a portion where the sheaths have melted and then solidified. At this point, the metal strands do not melt excessively, and maintain a degree of their original rigidity. Therefore, the plurality of coated metal wires overall are inhibited from taking on a liquid form in the process of forming the welded portion. In such a case, workability of a pressing step can be improved and the welded portion can be produced easily.

Furthermore, in the third aspect, the pair of side wall surfaces of the depression of the second die further include the second molding surfaces. Accordingly, the first outer surfaces corresponding to the second molding surfaces may be formed in addition to the inclined surfaces, which are formed by the first molding surfaces of the depression of the second die. In such a case, in a state where the welded portion is arranged inside the pair of crimping tabs of the pre-crimping terminal, a gap may be formed between the first outer surface of the welded portion and the inner surface of the pair of crimping tabs. Therefore, a portion toward a forefront end of the pair of crimping tabs readily covers the circumference of the welded portion, and the work of crimping the terminal and the welded portion together can be performed efficiently.

Furthermore, in the fourth aspect, the projection of the first die is inhibited from being inserted too far into the depression of the second die. As a result, it is possible to inhibit excessive pressure being applied to the welded portion formation region.

In the fifth aspect, also, similar to the first aspect, by bringing the inclined surface of the welded portion into contact with the inner surface of the pair of crimping tabs of the pre-crimping terminal, a state can be achieved where the welded portion is stably arranged inside the pair of crimping tabs of the pre-crimping terminal. Then, by performing the task of crimping the terminal and the welded portion together in such a state, the conductive member and the terminal can be crimped together more stably.

In addition, in the sixth aspect, similar to the second aspect, the metal strands do not melt excessively, and maintain a degree of their original rigidity. Therefore, the plurality of coated metal wires overall are inhibited from taking on a liquid form in the process of forming the welded portion. In such a case, workability of the pressing step can be improved and the welded portion can be produced easily.

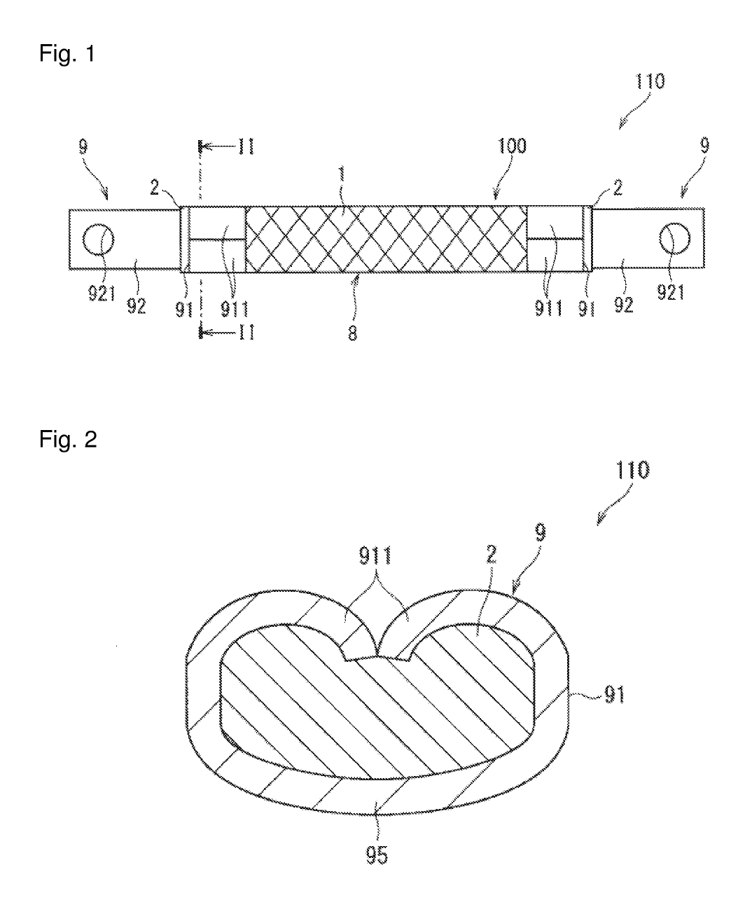

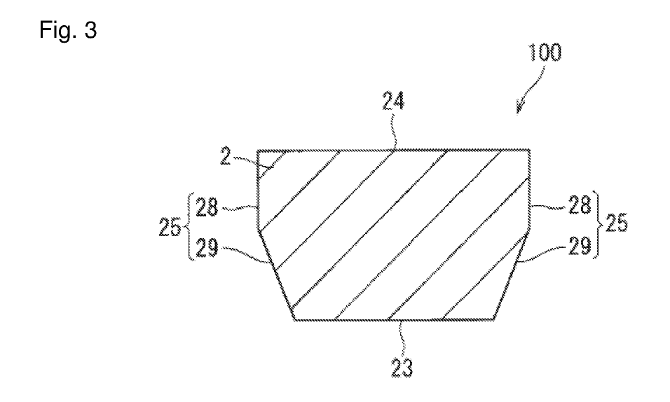

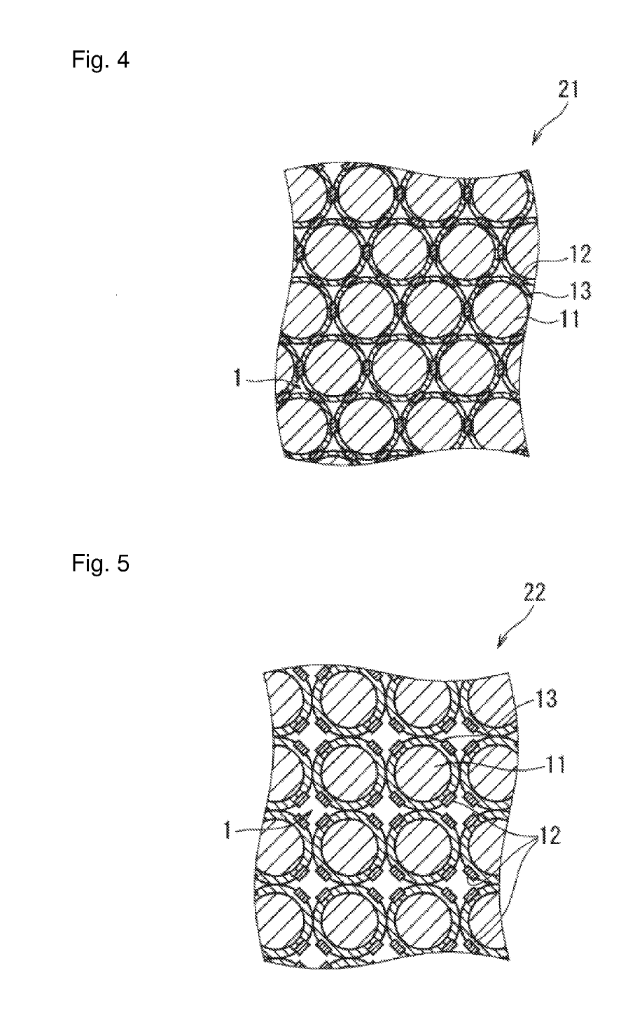

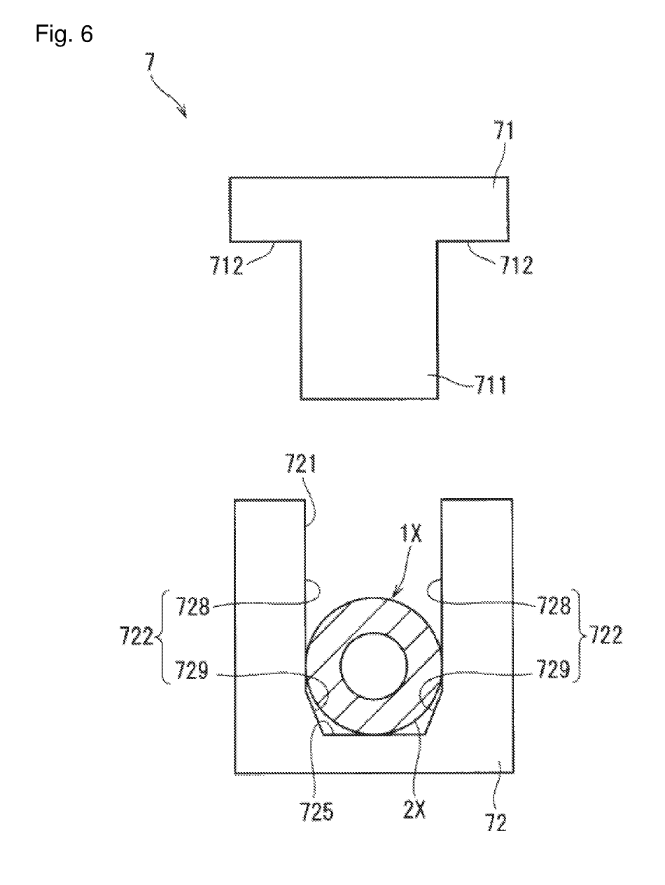

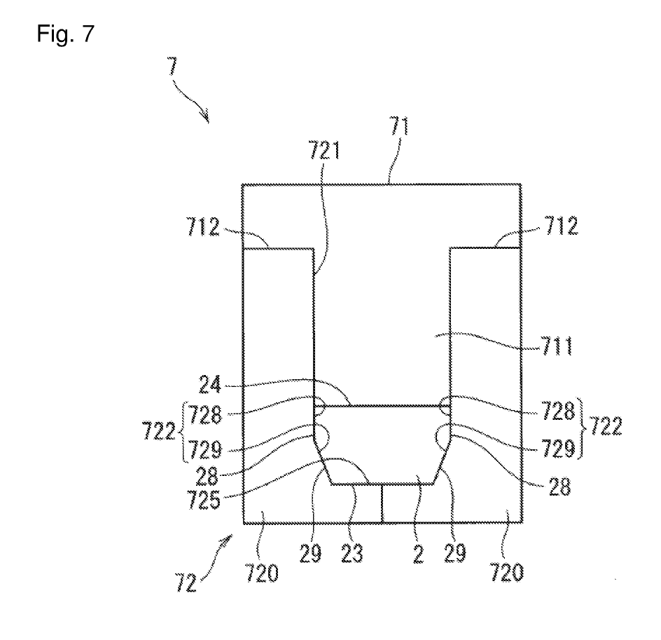

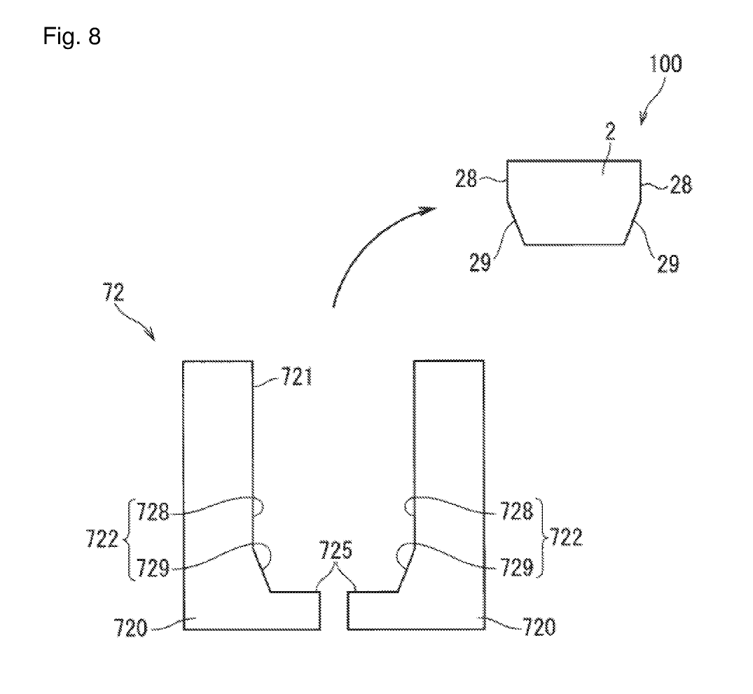

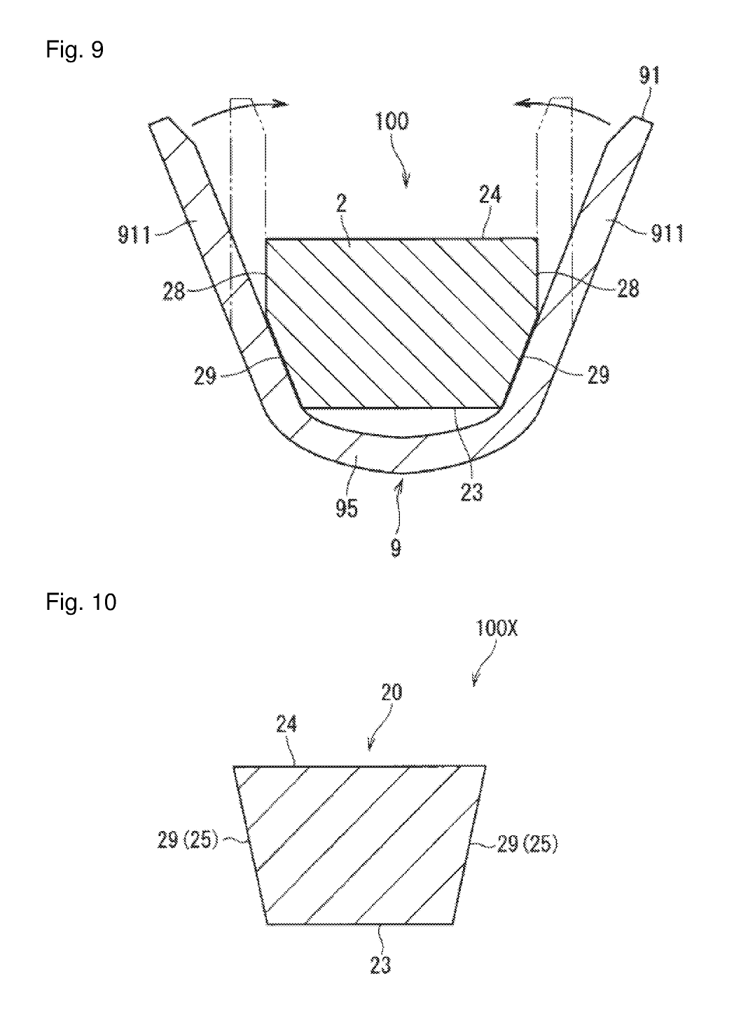

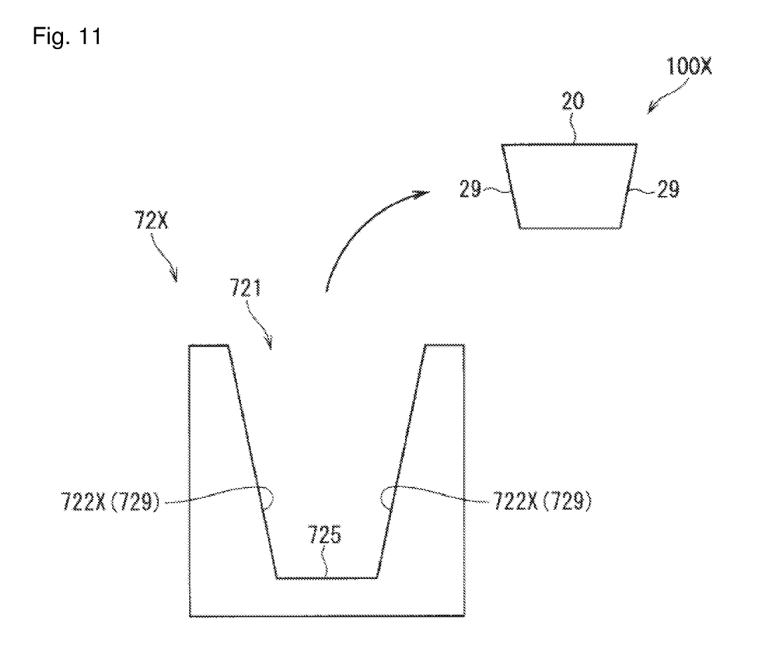

### BRIEF DESCRIPTION OF THE DRAWINGS

[FIG. 1] is a plan view of a terminal-equipped conductive member that includes a conductive member according to an embodiment.

[FIG. 2] is a cross-sectional view of the terminal-equipped conductive member that includes the conductive member according to the embodiment.

[FIG. 3] is a cross-sectional view of a welded portion of the conductive member according to the embodiment.

[FIG. 4] is an enlarged cross-sectional view of the welded portion of the conductive member according to the embodiment.

[FIG. 5] is an enlarged cross-sectional view of the welded portion of the conductive member according to the embodiment.

[FIG. 6] is an explanatory diagram illustrating a method of manufacturing the terminal-equipped conductive member according to the embodiment.

[FIG. 7] is an explanatory diagram illustrating the method of manufacturing the terminal-equipped conductive member according to the embodiment.

[FIG. 8] is an explanatory diagram illustrating the method of manufacturing the terminal-equipped conductive member according to the embodiment.

[FIG. 9] is an explanatory diagram illustrating the method of manufacturing the terminal-equipped conductive member according to the embodiment.

[FIG. 10] is a cross-sectional view of a welded portion of a conductive member according to a modification.

[FIG. 11] is an explanatory diagram illustrating a method of manufacturing a terminal-equipped conductive member according to the modification.

### MODE FOR CARRYING OUT THE INVENTION

Hereafter, an embodiment is described with reference to the attached drawings. The embodiment below is presented as an exemplary embodiment of the present invention and shall not be construed as limiting a technical scope of the present invention.

### Embodiment

A conductive member 100 and a method of manufacturing a terminal-equipped conductive member according to the embodiment are described with reference to FIGS. 1 to 9. The conductive member 100 is configured by a plurality of metal strands 11. In this example, the conductive member 100 is configured by a plurality of coated metal wires 1 that contain the plurality of metal strands 11. The conductive member 100 also includes a welded portion 2, where the plurality of coated metal wires 1 are welded together. The conductive member 100 may, for example, be a portion of a wire harness that is mounted in a vehicle such as an automobile.

To begin, the conductive member 100 and a terminal-equipped conductive member 110 that includes the conductive member 100 are described with reference to FIGS. 1 to 6. FIG. 1 is a plan view of the terminal-equipped conductive member 110. FIG. 2 is a cross-sectional view of the terminal-equipped conductive member 110, and provides a view of a section taken along a line II-II in FIG. 1. FIG. 3 is a schematic cross-sectional view of the welded portion 2 of the conductive member 100. FIGS. 4 and 5 are enlarged cross-sectional views of a portion of the welded portion 2 of the conductive member 100.

In the present embodiment, the conductive member 100 is configured by the plurality of coated metal wires 1. In addition, the conductive member 100 is formed so as to be pliant and capable of flexing at portions where the welded portion 2 is not formed.

As illustrated in FIGS. 4 and 5, each of the coated metal wires 1 is provided with a wire-like metal strand 11 and an electrically conductive sheath 12 covering a circumference of the metal strand 11. Here, an example is provided of a case where the sheath 12 is made of metal.

In the present embodiment, an exemplary case is described in which the metal strand 11 is copper and the sheath 12 is tin plating. In such a case, when the sheath 12 is plated onto the metal strand 11, an alloy portion 13 where the metal strand 11 and the sheath 12 are alloyed is produced on an outer circumferential surface of the metal strand 11. More specifically, the alloy portion 13 is formed covering a majority of the outer circumferential surface of the metal strand 11, whereas the sheath 12 survives on a portion of the outer circumferential surface of the coated metal wire 1. Accordingly, in this example, at the point in time where the sheath 12 is plated onto the metal strand 11, the coated metal wire 1 has a configuration that includes the metal strand 11, the sheath 12, and the alloy portion 13. A case may also be considered in which the metal strand 11 is a metal other than copper and the sheath 12 is not tin plating. Details are described hereafter.

In the present embodiment, the conductive member 100 is further configured by a braided wire in which the plurality of coated metal wires 1 are braided together. Other examples may include the conductive member 100 being configured by twisting together the plurality of coated metal wires 1, for example.

Here, as illustrated in FIG. 1, the conductive member 100 is produced by providing the welded portion 2 to each of two ends in the extension direction of the braided wire configured by the plurality of coated metal wires 1. As an example, a wire in which the plurality of the coated metal wires 1 are braided into a tubular shape, or a wire in which the plurality of coated metal wires 1 are braided into a sheet shape may be employed as the braided wire.

As illustrated in FIG. 1, the conductive member 100 includes the welded portion 2, in which at least a portion of the plurality of coated metal wires 1 are welded together in the extension direction of the coated metal wires 1, and a flex portion 8 that is not welded. In this example, the welded portion 2 is formed at each of two ends of the conductive member 100. In addition, the flex portion 8 is formed in a middle region between the welded portions 2 at the two ends. Other examples may include the welded portion 2 being formed at a portion of the middle region of the conductive member 100, for example.

In the present embodiment, the flex portion 8 is a portion that is formed to be pliant and capable of flexing. The flex portion 8 is a portion where the plurality of coated metal wires 1 are not bonded together. Therefore, the plurality of coated metal wires 1 can move in different directions from each other, can move in directions away from each other, and the like at the flex portion 8. In such a case, the conductive member 100 can be pliantly deformed at the flex portion 8.

Conversely, the welded portion 2 is a portion where at least a portion of the plurality of coated metal wires 1 are bonded together. In this example, as described below, the welded portion 2 is formed using a die 7 that includes a first die 71 and a second die 72, by heating and pressing the plurality of coated metal wires 1 from the outer circumference side. Therefore, in the present embodiment, the welded portion 2 includes an outer layer 21 that is formed on the outer circumference side by welding the plurality of coated metal wires 1 together. Moreover, the welded portion 2 is a portion that is crimped together with a terminal 9, and is more rigid than the flex portion 8.

A description is now given of the terminal 9 that is crimped to the welded portion 2. As illustrated in FIG. 1, in the present embodiment, the terminal 9 includes a crimping portion 91 and a connection portion 92. The terminal 9 is a member having a metal such as copper as a primary component. The terminal 9 is electrically and mechanically connected to the conductive member 100 by the crimping portion 91.

In this example, the crimping portion 91 includes a pair of crimping tabs 911 that are capable of being crimped onto the welded portion 2 of the conductive member 100. The pair of crimping tabs 911 are portions formed so as to stand upright from a base 95 of the terminal 9 and rise on each of two sides of the welded portion 2 prior to crimping. In the terminal-equipped conductive member 110, the pair of crimping tabs 911 of the crimping portion 91 are crimped with a forefront portion of each abutting the other, and are swaged in a state where the pair of crimping tabs 911 cover the circumference of the welded portion 2 of the conductive member 100.

In addition, the connection portion 92 is a portion capable of connecting to a mating member that is a connection mate to the terminal 9. In this example, the connection portion 92 is provided with, for example, a fastener hole 921 capable of being fastened by a bolt to a mating member such as a vehicle-side device.

A description is now given of the welded portion 2 that is crimped to the terminal 9. In the present embodiment, on the outer layer 21 of the welded portion 2, the plurality of metal strands 11 are bonded together by a portion where the sheaths 12 have melted and solidified. More specifically, in this example, when the sheath 12 is welded (plated) to the metal strand 11, the alloy portion 13 is formed, and the majority of the outer circumferential surface of the coated metal wires 1 is covered by the alloy portion 13, and the sheath 12 survives in a portion of the outer circumferential surface. Then, the surviving sheath 12 is melted and, in a state where the sheath 12 intervenes between adjacent coated metal wires 1, the adjacent coated metal wires 1 are bonded together by the subsequent solidification of the molten sheath 12. This bonds the plurality of metal strands 11 to each other with the sheath 12.

In the present embodiment, by performing heating at a temperature lower than the melting point of the alloy portion 13, when forming the welded portion 2, excessive melting of the metal strands 11 and the alloy portion 13 can be inhibited.

Further details follow. In the present embodiment, the metal strand 11 is copper and the sheath 12 is tin plating. In such a case, the melting point of the metal strand 11 (copper) may be approximately 1085°. In addition, the melting point of the sheath 12 (tin) is approximately 230°. Moreover, the melting point of the alloy portion 13 where the metal strand 11 and the sheath 12 are alloyed may be approximately 400 to 700° (for example, the melting point of Cu₃Sn is around 415°, and the melting point of Cu₆Sn₅ is around 676°). Accordingly, in this example, the welded portion 2 may be considered to form when heated to a temperature of 230° to less than 700° (for example, to a temperature of 300°). In such a case, the metal strand 11 is unlikely to melt and somewhat maintains its original shape (that is, wire-like) at the outer layer 21 of the welded portion 2. In addition, when the welded portion 2 is heated to a temperature lower than the melting point of the alloy portion 13, the alloy portion 13 is also unlikely to melt. Therefore, in this example, by primarily melting only the sheath 12, adjacent coated metal wires 1 are bonded together, thereby making it possible to inhibit the welded portion 2 from becoming excessively rigid. Furthermore, it is possible to inhibit the overall coated metal wire 1 from melting and taking on a liquid form in the process of forming the welded portion 2, and therefore the work of pressing with the die and the work of extracting the conductive member 100 from the die after forming the welded portion 2 can be performed easily.

In addition, due to crimping the terminal 9, at least a portion of the plurality of coated metal wires 1 at a portion on an inner side of the outer layer 21 (hereafter referred to as an inner layer 22) of the welded portion 2 can be considered to be capable of untwining.

Specifically, in the present embodiment, the inner layer 22 is a portion that contains a plurality of the coated metal wires 1 that are not bonded together. The plurality of coated metal wires 1 contained in the inner layer 22 are capable of untwining, and therefore the inner layer 22 can be considered to be a portion that is more flexible than the outer layer 21.

In this example, all of the coated metal wires 1 contained in the inner layer 22 are capable of untwining. In other words, as illustrated in FIG. 5, at the inner layer 22, the sheaths 12 do not melt and adjacent metal strands 11 are merely in contact with one another without being bonded together. In such a case, the inner layer 22 can be formed to be pliant and capable of allowing the plurality of coated metal wires 1 to deform when crimped to the terminal 9, and can inhibit the welded portion 2 from becoming excessively rigid.

The inner layer 22 can also be considered to further include a portion that includes both the plurality of coated metal wires 1 that are welded to each other and the plurality of coated metal wires 1 that are not bonded together. Specifically, the inner layer 22 can also be considered to include a portion where a subset of the plurality of coated metal wires 1 having the coated metal wires 1 welded to each other coexists with a subset having coated metal wires 1 that are capable of untwining. In such a case, an example may be considered where a portion exists at the inner layer 22 where the welded portion gradually changes over to the portion capable of untwining, the change occurring gradually from the outer layer 21 side toward the center of the inner layer 22 (i.e., toward the center of the welded portion 2).

In addition, as illustrated in FIG. 3, in the welded portion 2 of the conductive member 100, an outer surface 25 on each of the two lateral sides of the welded portion 2 includes an inclined surface 29 that inclines gradually outward, the incline progressing from one side of a thickness direction to the other. The thickness direction is a direction orthogonal to both the extension direction of the conductive member 100 and a direction running through the two outer surfaces 25 of the welded portion 2.

In this example, the inclined surface 29 is provided on a portion on one side of the welded portion 2 that touches the base 95 of the terminal 9. A first outer surface 28 is formed on a portion on the other side of the welded portion 2, the first outer surface 28 corresponding to a second molding surface 728 of the second die 72 described below. Specifically, in the present embodiment, the outer surface 25 of the welded portion 2 includes the inclined surface 29 formed on a portion on one side of the welded portion 2 and the first outer surface 28 formed on a portion on the other side of the welded portion 2.

Of the two surfaces of the welded portion 2 that face each other in the thickness direction, the surface on one side is referred to as a bottom surface 23 and the surface on the other side is referred to as a top surface 24. In addition, in the present embodiment, the portion furthest to one side of the inclined surface 29 is the edge shared with the bottom surface 23. Specifically, the inclined surface 29 is a surface that gradually inclines further outward, the incline progressing from the portion furthest to one side in the thickness direction of the welded portion 2 to the other side. In addition, in the present embodiment, the portion furthest to the other side of the first outer surface 28 is the edge shared with the top surface 24.

Another example may be considered in which the inclined surface 29 is formed to span from the bottom surface 23 to the top surface 24. Specifically, a case may also be considered in which the outer surface 25 does not include the first outer surface 28, and instead the portion of the inclined surface 29 furthest to one side is the edge shared with the bottom surface 23 and the portion of the inclined surface 29 furthest to the other side is the edge shared with the top surface 24. This is described in detail below.

In the welded portion 2, the inclined surface 29 is a surface that follows an inner surface of the pair of crimping tabs 911 prior to the crimping of the terminal 9 that is to be crimped to the welded portion 2. This example illustrates a case where the inclined surface 29 has a linear shape in a cross-sectional view orthogonal to the extension direction of the conductive member 100. However, depending on the shape of the pair of crimping tabs 911 of the terminal 9 that is to be crimped to the welded portion 2, the inclined surface 29 may also have a curved surface that inclines as the surface curves. Specifically, the inclined surface 29 may have a curved shape in a cross-sectional view orthogonal to the extension direction of the conductive member 100.

In addition, in the welded portion 2, the first outer surface 28 is a surface corresponding to the second molding surface 728 described below. The first outer surface 28 is a surface configured such that, in a state where the welded portion 2 is arranged inside the pair of crimping tabs 911 of the terminal 9 prior to crimping, a gap is formed between the pair of erect crimping tabs 911. In this example, as illustrated in FIG. 3, the first outer surface 28 is a surface that is orthogonal to the top surface 24 and the bottom surface 23. The first outer surface 28 may also be a surface that intersects slantwise with the top surface 24 and the bottom surface 23. The first outer surface 28 may also be a curved surface.

Next, a method of manufacturing a terminal-equipped conductive member according to the present embodiment is further described with reference to FIGS. 6 to 9. The method of manufacturing a terminal-equipped conductive member is performed using the die 7, which includes the first die 71 having a projection 711 and the second die 72 having a depression 721 into which the projection 711 can be inserted. A pair of side wall surfaces 722 of the depression 721 of the second die 72 include a first molding surface 729 that is inclined along the inner surface of the pair of crimping tabs 911 of the pre-crimping terminal 9.

The method of manufacturing a terminal-equipped conductive member includes a welding step of arranging in the die 7 a welded portion formation region 2X, which is a region on an extension direction portion of the conductive member 100, the conductive member 100 being configured by the plurality of metal strands 11 (in this example, the plurality of coated metal wires 1), and welding the plurality of metal strands 11 (in this example, the plurality of coated metal wires 1) together; and a crimping step of arranging on the interior of the pair of crimping tabs 911 of the pre-crimping terminal 9 the welded portion 2, which is formed by performing the welding step on the welded portion formation region 2X and which is formed with the inclined surface 29 corresponding to the first molding surface 729 of the second die 72, and crimping the welded portion 2 and the terminal 9 together. In the present embodiment, a pressing step is further provided where the heated welded portion formation region 2X is held between the projection 711 of the first die 71 and the depression 721 of the second die 72 and is pressed. In such a case, the welded portion 2 is formed by performing the welding step and the pressing step on the welded portion formation region 2X.

In the present embodiment, the method of manufacturing a terminal-equipped conductive member includes a first step of setting the welded portion formation region 2X in the die 7; a second step of hot pressing the welded portion formation region 2X using the die 7; a third step of extracting from the die 7 the conductive member 100 on which the welded portion 2 has been formed; and a fourth step of crimping the crimping portion 91 of the terminal 9 to the welded portion 2 of the extracted conductive member 100. Also, in this example, the second step is a step that includes the welding step and the pressing step described above. Furthermore, the fourth step is a step that includes the crimping step described above.

FIGS. 6 to 9 are explanatory diagrams illustrating the method of manufacturing the terminal-equipped conductive member according to the present embodiment. FIG. 6 is an explanatory diagram illustrating the first step described above. FIG. 7 is an explanatory diagram illustrating the second step described above. FIG. 8 is an explanatory diagram illustrating the third step described above. FIG. 9 is an explanatory diagram illustrating the fourth step described above.

First, the die 7 is described with reference to FIGS. 6 to 9. In the die 7, the first die 71 and the second die 72 are configured such that one or both can approach and be separated from the other. In addition, in this example, the first die 71 and the second die 72 are configured to be capable of heating the welded portion formation region 2X. A case can be considered, for example, where a heating device such as a heater is installed in the first die 71 and the second die 72. In such a case, the outer surface of the projection 711 of the first die 71 and the inner surface of the depression 721 of the second die 72 are heated by the heating device to a temperature that causes the sheath 12 of the coated metal wire 1 to melt.

In the present embodiment, in order for the second die 72 to enable the conductive member 100 on which the welded portion 2 has been formed to be readily extracted from the depression 721, the second die 72 is configured by combining a plurality of separable second die pieces 720. In particular, in order to enable ready extraction of the welded portion 2 on which is formed the first outer surface 28 extending in a depth direction of the depression 721, the second die 72 includes the plurality of separable second die pieces 720. More specifically, in this example, the second die 72 includes two second die pieces 720, which are configured to be separable in a direction in which the pair of side wall surfaces 722 (described below) face each other. In addition, when the second die pieces 720 are combined, the depression 721 in which the plurality of coated metal wires 1 can be arranged is formed in the second die 72. Another example can, of course, also be considered in which the second die 72 is a single die in which the depression 721 is formed.

The first die 71 is provided with the projection 711, which can be inserted into the depression 721 of the second die 72. In this example, as illustrated in FIG. 7, the projection 711 of the first die 71 is inserted into the depression 721 by bringing the projection 711 close to the second die 72 in a state where the projection 711 is opposite the depression 721 of the second die 72. Thereby, the plurality of coated metal wires 1 arranged in the depression 721 are held between the first die 71 and the second die 72, and pressure is applied to the coated metal wires 1.

In addition, as illustrated in FIG. 7, in the present embodiment, the first die 71 includes a contact portion 712 that, when the projection 711 is inserted into the depression 721 by a predetermined amount, makes contact with a portion (top portion) of the depression 721 of the second die 72 that faces the first die 71. In this example, as illustrated in FIGS. 6 and 7, the contact portion 712 projects outward from two sides of the projection 711. The contact portion 712 inhibits the projection 711 of the first die 71 from being inserted too far into the depression 721 of the second die 72, and inhibits excessive pressure being applied to the plurality of coated metal wires 1.

The depression 721 of the second die 72 is formed by combining the two second die pieces 720, and includes a bottom surface 725 where the welded portion formation region 2X is arranged, and the pair of side wall surfaces 722 projecting from the bottom surface 725. In this example, the bottom surface 725 is a surface supporting the welded portion formation region 2X arranged within the depression 721.

In addition, in the present embodiment, the side wall surfaces 722 each include not only the first molding surface 729 but also the second molding surface 728. In this example, as illustrated in FIG. 6, the side wall surface 722 includes the first molding surface 729, which is provided toward a bottom portion (bottom surface 725) of the depression 721, and the second molding surface 728, which is provided on an opposite side of the first molding surface 729 from the bottom surface 725 side (that is, on a side of the first molding surface 729 toward the top portion of the depression 721). The second molding surface 728 is a surface that extends along a direction in which the first die 71 and the second die 72 separate from each other.

The first molding surface 729 is a surface that is formed so as to incline along the inner surface of the pair of crimping tabs 911 of the pre-crimping terminal 9 and, in this example, is an inclined planar surface that is inclined such that a distance between the pair of side wall surfaces 722 gradually narrows toward the bottom surface 725. Depending on the shape of the pair of crimping tabs 911 of the pre-crimping terminal 9, the first molding surface 729 may also have a curved inclined surface.

The second molding surface 728 is a surface that is formed on the opposite side of the first molding surface 729 from the bottom surface 725. In this example, as illustrated in FIG. 6, the second molding surface 728 is a surface that is orthogonal to the bottom surface 725. The second molding surface 728 may also be a surface with a smaller incline than the first molding surface 729. The second molding surface 728 may also be a curved inclined surface, rather than an inclined planar surface.

Hereafter, a detailed description is given of the first step, second step, third step, and fourth step in a method of manufacturing a conductive member according to the present embodiment.

First, in the present embodiment, as illustrated in FIG. 6, in the first step, a braided wire 1X configured by the plurality of coated metal wires 1 is arranged in the depression 721 of the second die 72 so as to be in contact with the bottom surface 725 of the depression 721. In this example, in order to form the welded portion 2 at the end portion of the conductive member 100, an end portion of the braided wire 1X is arranged in the depression 721 of the second die 72. Specifically, in this example, an end portion in the extension direction of the braided wire 1X is the welded portion formation region 2X.

After the first step, the second step is performed. The second step includes a welding step and a pressing step. In the present embodiment, as illustrated in FIG. 7, in the second step, the heated first die 71 and second die 72 each approach each other, or one approaches the other, and the welded portion formation region 2X on the end portion of the braided wire 1X is pressed. Specifically, the welding step and the pressing step are performed at the same point in time. The first die 71 and the second die 72 are heated at least prior to beginning the second step. For example, a case may be considered in which the first die 71 and the second die 72 are already heated prior to beginning the first step, or the first die 71 and the second die 72 are heated beginning partway through the first step.

Also, in the welding step of the present embodiment, heating is performed at a temperature higher than the melting point of the sheath 12 and lower than the melting point of the metal strand 11. In this example, the welding step is a step where heating is performed at a temperature higher than the melting point of the sheath 12 and lower than the melting point of the alloy portion 13 where the metal strand 11 and the sheath 12 are alloyed, and is a step where the plurality of coated metal wires 1 are welded to each other. In such a case, the metal strand 11 and the alloy portion 13 are unlikely to melt, and the overall welded portion formation region 2X can be inhibited from taking on a liquid form. Therefore, workability in the pressing step using the die 7 is improved. In addition, the work of extracting the conductive member 100 from the die 7 after forming the welded portion 2, and the like, can be performed easily.

More specifically, in the welding step of the present embodiment, the surface of the die 7 in contact with the welded portion formation region 2X is heated at a temperature higher than the melting point of the sheath 12 and lower than the melting point of the alloy portion 13 where the metal strand 11 and the sheath 12 are alloyed. Then, by pressing the welded portion formation region 2X at the end portion of the braided wire 1X with the die 7, a state is created on the outer circumference of the welded portion formation region 2X in which the temperature is higher than the melting point of the sheath 12, and a state is created toward the center of the welded portion formation region 2X in which the temperature is lower than the melting point of the sheath 12. For example, a heating temperature and heating time of the die 7, a pressing time for which the welded portion formation region 2X is pressed by the die 7, a pressure applied to the welded portion formation region 2X by the die 7, and the like can be adjusted in view of the number of coated metal wires 1 contained in the welded portion formation region 2X, or the like, in order to achieve such states.

In the present embodiment, a state is created on the outer circumference of the welded portion formation region 2X in which the temperature is higher than the melting point of the sheath 12, enabling primarily the sheath 12 that survives on the outer circumferential surface of the coated metal wires 1 to be melted. In this example, heating is performed at a temperature greater than the melting point of the sheath 12 and lower than the melting point of the alloy portion 13, and therefore the alloy portion 13 of the welded portion formation region 2X is comparatively unlikely to melt, and the overall welded portion formation region 2X can be inhibited from taking on a liquid form. More specifically, prior to heating, the majority of the outer circumferential surface of the coated metal wire 1 is constituted by the alloy portion 13, and the remainder of the outer circumferential surface of the coated metal wire 1 is constituted by the surviving sheath 12. The sheath 12 is primarily melted by heating, and by performing the pressing with the die 7 in this state, adjacent coated metal wires 1 contact each other. Then, the melting sheath 12 solidifies in the state where the adjacent coated metal wires 1 contact each other, and thereby the adjacent coated metal wires 1 (that is, the metal strands 11 for which a majority of the surface is covered by the alloy portion 13) are bonded to each other. This portion constitutes the outer layer 21 on the conductive member 100.

Meanwhile, at the portion toward the center of the welded portion formation region 2X, heat from the die 7 is not readily transmitted. Therefore, this portion is in a state having a temperature lower than the melting point of the sheath 12. As a result, toward the center of the welded portion formation region 2X, a state is maintained where the sheath 12 does not melt and the plurality of coated metal wires 1 are untwined. This forms the inner layer 22.

In addition, by performing the hot pressing work of the second step, the welded portion 2 is formed, the outer surface 25 of the welded portion 2 being formed with the inclined surface 29 corresponding to the first molding surface 729 of the depression 721 of the second die 72 and the first outer surface 28 corresponding to the second molding surface 728.

After the second step, the third step is performed. As illustrated in FIG. 8, in the third step, the first die 71 is separated from the second die 72 and the conductive member 100 is extracted, the conductive member 100 including the welded portion 2, the outer surface 25 of which is formed on both sides with the inclined surface 29 and the first outer surface 28. In this example, as illustrated in FIG. 8, by disassembling the second die 72 into the two die pieces 720 when the conductive member 100 is extracted, the conductive member 100, which includes the welded portion 2 with the first outer surface 28 formed thereon, can be easily extracted from the die 7. Accordingly, the conductive member 100 having the welded portion 2 formed on the end portion thereof can be obtained.

After the third step, the fourth step is performed. As illustrated in FIG. 9, in the fourth step, first the welded portion 2 of the conductive member 100 is arranged inside the pair of crimping tabs 911 of the crimping portion 91 of the pre-crimping terminal 9. Then, the welded portion 2 is swaged and crimped such that the pair of crimping tabs 911 cover the circumference of the welded portion 2.

In the fourth step, for example, in a state where the welded portion 2 is arranged inside the pair of crimping tabs 911 of the pre-crimping terminal 9, the terminal 9 and the welded portion 2 are set on a terminal crimping device that is provided with a crimper and an anvil, and the terminal 9 is crimped to the welded portion 2 by swaging the pair of crimping tabs 911 with the crimper and anvil.

In this example, in the state where the welded portion 2 is arranged inside the pair of crimping tabs 911 of the crimping portion 91 of the pre-crimping terminal 9, the inclined surface 29 formed on the welded portion 2 is supported in a state where the inclined surface 29 lies along the inner surface of the pair of crimping tabs 911. Accordingly, the welded portion 2 is stably arranged within the pair of crimping tabs 911 of the pre-crimping terminal 9.

In the example given in Patent Literature 1, for example, even when a tolerance for an outer diameter of a single metal wire is small, the tolerance tends to become larger for the outer diameter of a braided wire configured by gathering a plurality of the metal wires. When the tolerance for the diameter of the braided wire is large, variation in the size of a swaged portion formed at an end portion of the braided wire is likely to occur. Accordingly, placement of the swaged portion in a crimping portion of a pre-crimping terminal is likely to become unstable, and as a result, a state of crimping to the crimping portion of the terminal is also likely to become unstable.

However, in the present embodiment, the inclined surface 29 is formed in the outer surface 25 on two sides of the welded portion 2, the inclined surface 29 lying along the inner surface of the pre-crimping pair of crimping tabs 911. Therefore, even when the size of the welded portion 2 varies, the welded portion 2 is supported and stably placed at least at the location of the inclined surface 29 in a state lying along the inner surface of the pre-crimping pair of crimping tabs 911. As a result, the state of crimping the terminal 9 and the welded portion 2 together can be stabilized.

In addition, as illustrated in FIG. 9, in the present embodiment, the outer surface 25 of the welded portion 2 includes the first outer surface 28. In this example, in a state where the welded portion 2 is arranged inside the pre-crimping pair of crimping tabs 911, there is a gap between the crimping tabs 911 and the first outer surface 28. Also, after crimping has begun, the pair of crimping tabs 911 first deform so as to fill the gap between the crimping tabs 911 and the first outer surface 28, and make contact with the first outer surface 28. Then, each tab of the pair of crimping tabs 911 is swaged so as to cover the circumference of the welded portion 2 in a state where the pair of crimping tabs 911 are in contact with the first outer surface 28 on both sides. In such a case, a state can be achieved where a portion toward the forefront end of the pair of crimping tabs 911 readily covers the circumference of the welded portion 2 with a comparatively weak force after crimping has begun. As a result, it is possible to both reduce the force applied during crimping and increase the stability of the state of crimping to the terminal 9.

As illustrated in FIG. 9, in this example, the inner surface of the pair of crimping tabs 911 and the inner surface of the base 95 of the crimping portion 91 have different shapes. For example, an incline or curvature of the inner surface of the pair of crimping tabs 911 is different from the incline or curvature of the base 95 of the crimping portion 91. In such a case, there is only one mode in which the welded portion 2 is supported by the pair of crimping tabs 911.

By completing the fourth step, the terminal 9 is crimped to the welded portion 2 of the conductive member 100 and the terminal-equipped conductive member 110 can be obtained. In this example, as described above, the outer circumferential surface of the welded portion 2 is covered by a portion where the sheath 12 has melted and then solidified, and there are no protruding metal strands 11 in the terminal 9. Therefore, in the terminal-equipped conductive member 110, the metal strands 11 of the conductive member 100 are inhibited from protruding between the pair of crimping tabs 911.

In the present embodiment, the welded portion 2 is formed at two ends and the terminal 9 is crimped to each of the two ends. Therefore, the first through fourth steps described above are also performed at the other end.

### Effects

The method of manufacturing a terminal-equipped conductive member according to the present embodiment is performed using the die 7, which includes the first die 71 having the projection 711 and the second die 72, the second die 72 having the depression 721 into which the projection 711 can be inserted, and having the pair of side wall surfaces 722 of the depression 721 which include the first molding surface 729, the first molding surface 729 being inclined along the inner surface of the pair of crimping tabs 911 of the pre-crimping terminal 9. In addition, the welded portion 2 is formed by performing the welding step. In such a case, the inclined surface 29 is formed on the welded portion 2, the inclined surface 29 corresponding to the first molding surface 729 of the depression 721 of the second die 72. The inclined surface 29 formed on the welded portion 2 is a surface that inclines along the inner surface of the pair of crimping tabs 911 of the pre-crimping terminal 9. Therefore, in the crimping step, by bringing the inclined surface 29 of the welded portion 2 into contact with the inner surface of the pair of crimping tabs 911 of the pre-crimping terminal 9, a state can be achieved where the welded portion 2 is stably arranged inside the pair of crimping tabs 911 of the pre-crimping terminal 9. Then, by performing the task of crimping the terminal 9 and the welded portion 2 together in such a state, the conductive member 100 and the terminal 9 can be crimped together more stably.

In addition, in the present embodiment, the plurality of metal strands 11 are bonded together by a portion where the sheaths 12 have melted and then solidified. In this example, by primarily melting only the sheaths 12, adjacent coated metal wires 1 are bonded together, and the welded portion 2 is formed. In such a case, it is possible to inhibit the welded portion 2 from becoming excessively rigid. In addition, the coated metal wires 1 are not excessively heated in the process of forming the welded portion 2, and therefore the end portions of the plurality of coated metal wires 1 overall can be inhibited from taking on a liquid form. Specifically, the metal strands 11 do not melt and maintain a degree of rigidity, and therefore the work of extraction from the die 7 and the work of pressing, for example, can be performed easily. As a result, the welded portion 2 can be provided easily. In this example, the alloy portions 13 covering the majority of the outer circumferential surface of the metal strands 11 also do not melt, and therefore the welded portion 2 can be provided still more easily.

Furthermore, in the present embodiment, the pair of side wall surfaces 722 of the depression 721 of the second die 72 further include the second molding surfaces 728. Accordingly, the first outer surfaces 28 corresponding to the second molding surfaces 728 may be formed in addition to the inclined surfaces 29, which are formed by the first molding surfaces 729 of the depression 721 of the second die 72. In such a case, in a state where the welded portion 2 is arranged inside the pair of crimping tabs 911 of the pre-crimping terminal 9, a gap may be formed between the first outer surfaces 28 of the welded portion 2 and the inner surface of the pair of crimping tabs 911. Therefore, the portion toward the forefront end of the pair of crimping tabs 911 readily covers the circumference of the welded portion 2, and the work of crimping the terminal 9 and the welded portion 2 together can be performed efficiently.

Furthermore, in the present embodiment, the first die 71 includes the contact portion 712, and therefore the projection 711 of the first die 71 is inhibited from being inserted too far into the depression 721 of the second die 72. As a result, it is possible to inhibit excessive pressure being applied to the welded portion formation region 2X.

Modifications

A conductive member 100X and a method of manufacturing a terminal-equipped conductive member according to a modification are described with reference to FIGS. 10 and 11. FIG. 10 is a schematic cross-sectional view of a welded portion 20 of the conductive member 100X. FIG. 11 is an explanatory diagram illustrating a third step in the method of manufacturing the terminal-equipped conductive member according to the modification. In FIGS. 10 and 11, the same reference numerals are assigned to components that are identical to those depicted in FIGS. 1 to 9.

This example differs from the embodiment in that the inclined surface 29 is formed to span from the bottom surface 23 to the top surface 24. Specifically, as illustrated in FIG. 10, in this example, the outer surface 25 of the welded portion 20 does not include the first outer surface 28, and instead the portion of the inclined surface 29 furthest to one side is the edge shared with the bottom surface 23 and the portion of the inclined surface 29 furthest to the other side is the edge shared with the top surface 24.

This example also differs from the embodiment in that, of the dies used in the method of manufacturing a terminal-equipped conductive member, a bottom die 72X is a single die in which the depression 721 is formed. The shape of the depression 721 of the bottom die 72X also differs from that in the embodiment.

In this example, as illustrated in FIG. 11, a pair of side wall surfaces 722X of the depression 721 include only the first molding surface 729. In this example, the first molding surface 729 is an inclined surface having a planar configuration that is inclined such that a distance between the pair of side wall surfaces 722X gradually narrows toward the bottom surface 725. An example may also be considered where the first molding surface 729 is an inclined surface having a curved configuration. In this example, the pair of side wall surfaces 722X overall are configured by inclined surfaces, and therefore a conductive member 100X on which the welded portion 20 is formed can be readily extracted from the die.

### Exemplary Applications

An example may also be considered for the coated metal wire 1 where, when the metal strand 11 is copper, the sheath 12 is nickel plating, silver plating, or the like.

Another example may also be considered for the coated metal wire 1 where the metal strand 11 is a metal other than copper. For example, the metal strand 11 may be a metal principally composed of aluminum. In such a case, an example may be considered where the sheath 12 is zinc plating, tin plating, or the like.

A case may also be considered where, in the welding step, the plurality of metal strands 11 or the plurality of coated metal wires 1 in the welded portion formation region 2X are welded to one another due to a weld such as resistance welding or ultrasonic welding. In such a case, an example may be considered where the work of welding is performed in a state where the welded portion formation region 2X is arranged within the die 7 and then pressing is performed, thereby forming the welded portion 2.

A case may also be considered where the crimping step is performed in a state where the bottom surface 23 of the welded portion 2 is in contact with the base 95 of the crimping portion 91 of the terminal 9. At this point, a case may be considered where the bottom surface 23 of the welded portion 2 is a surface that lies along the inner surface of the base 95 of the crimping portion 91 of the pre-crimping terminal 9.

The method of manufacturing a terminal-equipped conductive member and the conductive member according to the present invention can also be configured by freely combining the embodiments, modifications, and exemplary applications given above, or by appropriately modifying or omitting portions of the embodiments, modifications, and exemplary applications, within the scope of the invention established in each of the claims.

### DESCRIPTION OF REFERENCE NUMERALS

1 Coated metal wire

100 Conductive member

11 Metal strand

12 Sheath

2 Welded portion

29 Inclined surface

2X Welded portion formation region

7 Die

71 First die

711 Projection

712 Contact portion

72 Second die

721 Depression

722 Side wall surface

728 Second molding surface

729 First molding surface

9 Terminal

91 Crimping portion

911 Crimping tab

1. A method of manufacturing terminal-equipped conductive member that is performed using a die, which includes a first die having a projection and a second die, the second die having a depression into which the projection can be inserted, and having a pair of side wall surfaces of the depression which include a first molding surface inclined along an inner surface of a pair of crimping tabs of a pre-crimping terminal, the method comprising:
arranging in the die a welded portion formation region, which is a region on an extension direction portion of a conductive member configured by a plurality of metal strands, and welding the plurality of metal strands together; and
arranging on an interior of the pair of crimping tabs of the pre-crimping terminal a welded portion formed by performing the welding on the welded portion formation region and formed with an inclined surface corresponding to the first molding surface of the second die, and crimping the welded portion and the terminal together,
wherein the welded portion formation region includes an outer layer that is formed on an outer circumferential surface side of the welded portion formation region by welding the plurality of metal strands together and, on an inner side of the outer layer, at least a portion of the plurality of metal strands are made capable of untwining due to crimping the terminal.

2. The method of manufacturing a terminal-equipped conductive member according to claim 1 wherein the conductive member is configured by a plurality of coated metal wires provided with the plurality of metal strands and with an electrically conductive sheath covering a circumference of each of the plurality of metal strands, and
the welding includes heating performed at a temperature higher than the melting point of the sheaths and lower than the melting point of the metal strands, and the plurality of coated metal wires are welded to each other.

3. The method of manufacturing a terminal-equipped conductive member according to claim 1 wherein the pair of side wall surfaces include the first molding surface provided toward a bottom portion of the depression, and a second molding surface provided on an opposite side of the first molding surface from the bottom portion and extending along a direction in which the first die and the second die separate from each other.

4. The method of manufacturing a terminal-equipped conductive member according to claim 1 wherein the first die includes a contact portion that, when the projection is inserted into the depression by a predetermined amount, makes contact with a portion of the depression of the second die that faces the first die.

5. A conductive member configured by a plurality of metal strands and having a pair of crimping tabs of a terminal crimped thereto, wherein
the conductive member includes a welded portion where at least a portion in an extension direction of the plurality of metal strands is welded,
an outer surface on each of two lateral sides of the welded portion includes an inclined surface that inclines gradually outward, the incline progressing from one side of a thickness direction to the other so as to lie along an inner surface of the pair of crimping tabs of the terminal prior to crimping, and
the welded portion includes an outer layer that is formed on an outer circumferential surface side of the welded portion by welding the plurality of metal strands together and, on an inner side of the outer layer, at least a portion of the plurality of metal strands are made capable of untwining due to crimping the terminal.

6. The conductive member according to claim 5 wherein the conductive member is configured by a plurality of coated metal wires provided with the plurality of metal strands and with an electrically conductive sheath covering a circumference of each of the plurality of metal strands, and
the welded portion includes a portion where the plurality of metal strands are bonded together by a portion where the sheaths have melted and solidified.

7. A method of manufacturing a terminal-equipped conductive member according to claim 2 wherein the plurality of metal strands are welded together not by an alloy portion that is formed when the circumference of the metal strand is covered by the sheath, but rather are welded together by the sheath that survives on a portion of the outer circumferential surface of the metal strand.

8. A conductive member according to claim 6 wherein, in the welded portion, the plurality of metal strands are welded together not by an alloy portion that is formed when the circumference of the metal strand is covered by the sheath, but rather are welded together by the sheath that survives on a portion of the outer circumferential surface of the metal strand.

9. A terminal-equipped conductive member that is provided with a conductive member configured by a plurality of metal strands, and a terminal that includes a crimping portion that is crimped to the conductive member, wherein
the conductive member includes a welded portion where at least a portion in an extension direction of the plurality of metal strands is welded, and an outer surface on each of two lateral sides of the welded portion includes an inclined surface that inclines gradually outward, the incline progressing from one side of a thickness direction to the other,
the welded portion includes an outer layer that is formed on an outer circumferential surface side of the welded portion by welding the plurality of metal strands together and, on an inner side of the outer layer, at least a portion of the plurality of metal strands are made capable of untwining due to crimping the terminal,
the crimping portion includes a pair of crimping tabs, and
in a condition in which the inclined surface is arranged inside the crimping tabs of the crimping portion, the crimping portion is crimped to the welded portion while causing the inner side of the outer layer to deform.

10. The terminal-equipped conductive member according to claim 9 wherein an electrically conductive sheath covers a circumference of each of the plurality of metal strands and, in the welded portion, the plurality of metal strands are welded together not by an alloy portion that is formed when the circumference of the metal strand is covered by the sheath, but rather are welded together by the sheath that survives on a portion of the outer circumferential surface of the metal strand.
